(19) United States
(12) Patent Application Publication
(10) Pub. No.: US 2024/0346532 A1
(43) Pub. Date: Oct. 17, 2024

(54) SERVICE DEMAND POTENTIAL PREDICTION DEVICE

(71) Applicant: NTT DOCOMO, INC., Tokyo (JP)

(72) Inventors: Keita YOKOYAMA, Chiyoda-ku (JP); Kenji SHINODA, Chiyoda-ku (JP); Shigeki TANAKA, Chiyoda-ku (JP); Norihiro KATSUMARU, Chiyoda-ku (JP); Shohei YOSHIDA, Chiyoda-ku (JP)

(73) Assignee: NTT DOCOMO, INC., Tokyo (JP)

(21) Appl. No.: 18/689,725

(22) PCT Filed: Jul. 20, 2022
(86) PCT No.: PCT/JP2022/028215

§ 371 Date: Mar. 6, 2024

(30) Foreign Application Priority Data
Sep. 10, 2021 (JP) 2021-147670

(51) Int. Cl. G06Q 30/0202

(52) U.S. Cl. CPC G06Q 30/0202

(57) ABSTRACT

A service demand potential prediction device (10) includes: an acquisition unit (11) for acquiring the number of service provision results for own-company service and other-company service for each area; a calculation unit (12) for calculating a relative index of the own-company service to the other-company service for each area; a selection unit (13) for selecting a dominant area where the own-company service is dominant; a construction unit (14) for constructing a model (M) by performing machine learning using a characteristic amount of the dominant area as an explanatory variable and the number of service provision results of the own-company service as an objective variable; and a prediction unit (15) for predicting a service demand potential of the own-company service when the non-dominant area is assumed to be a dominant area by inputting the characteristic amount of the non-dominant area into the model (M).

### TECHNICAL FIELD

The present disclosure relates to a service demand potential prediction device for predicting an index (hereinafter referred to as a “service demand potential”) indicating how much the demand for a certain service may further increase than the current demand for the certain service for each predetermined area.

In the present disclosure, the “area” may be, for example, a rectangular area divided and formed by a boundary line extending from east to west, from north to south, or a presence area managed by a base station, and the shape and size of the area may be variously set.

### BACKGROUND ART

Enterprises that develop and provide a service in an area have a need to forecast the service demand potential for the service for each area and to execute strategic sales activities such as conducting sales activities for the service provision targeting areas with high service demand potential based on the forecast results. A technique for predicting the service demand potential for each area as described above is proposed in the following Patent Document 1, for example.

### CITATION LIST

### Patent Document

Patent Document 1: Japanese Patent Application Laid-Open No. 2020-086790

### SUMMARY OF INVENTION

### Technical Problem

In reality, when considering a business model that provides services in various areas, there are almost always competing companies (especially those with similar service provision results and corporate scale to one's own company) that provide similar services in the same area. It is desirable to predict the service demand potential by considering not only information related to own-company service provision but also information related to the service provision of competing companies. However, Patent Document 1 does not consider information about competing companies.

The present disclosure has been made in order to solve the above-mentioned problems, and an object of the present disclosure is to accurately predict a service demand potential for each area in consideration of not only information related to the own-company service provision but also information related to the service provision of a competitor.

### Solution to Problem

A service demand potential prediction device includes: an acquisition unit that acquires the number of service provision results for each of a target own-company service and an other-company service used for calculating a relative index indicating a relative ratio to the own-company service with respect to the number of service provision results, for each predetermined area; a calculation unit that calculates the relative index of the own-company service to the other-company service for each area based on the acquired number of service provision results for each of the target own-company service and the other-company service, for each area; a selection unit that selects a dominant area in which the number of service provision results of the own-company service is relatively dominant, based on information including the calculated relative index for each area; a construction unit that performs machine learning using a characteristic amount representing a characteristic of the selected dominant area as an explanatory variable and the number of service provision results of the own-company service in the selected dominant area as an objective variable, and constructs a machine learning model for predicting a demand for service provision in the dominant area; a prediction unit that predicts a service provision prediction number of the own-company service in a case where a non-dominant area is assumed to be a dominant area by inputting a characteristic amount representing a characteristic of the non-dominant area which is not the dominant area into the constructed machine learning model, and sets the obtained service provision prediction number as a service demand potential in the non-dominant area.

In the above-mentioned service demand potential prediction device, an acquisition unit acquires the number of service provision results for each of a target own-company service and an other-company service used for calculating a relative index indicating a relative ratio to the own-company service with respect to the number of service provision results, for each predetermined area, a calculation unit calculates the relative index of the own-company service to the other-company service for each area based on the acquired number of service provision results for each of the target own-company service and the other-company service, for each area a selection unit selects a dominant area in which the number of service provision results of the own-company service is relatively dominant, based on information including the calculated relative index for each area, and a construction unit performs machine learning using a characteristic amount representing a characteristic of the selected dominant area as an explanatory variable and the number of service provision results of the own-company service in the selected dominant area as an objective variable, and constructs a machine learning model for predicting a demand for service provision in the dominant area. As described above, the machine learning model for predicting the demand for service provision in the dominant area is constructed, and then the prediction unit predicts a service provision prediction number of the own-company service in a case where a non-dominant area is assumed to be a dominant area by inputting a characteristic amount representing a characteristic of the non-dominant area which is not the dominant area into the constructed machine learning model, and sets the obtained service provision prediction number as a service demand potential in the non-dominant area. As described above, it is possible to accurately predict a service demand potential for each area in consideration of not only information related to the own-company service provision but also information related to the service provision of a competitor. Further, the service demand potential can be predicted relatively easily as described above by using a relative index for each area obtained on the basis of the number of service provision results for both the own-company service and the other-company service in each area without using a detailed and large data for predicting the demand for service provision.

It should be noted that the “service” corresponds to, for example, an electronic payment service described in the embodiment of the invention, and in addition to this, a service rooted in an area (for example, a bicycle sharing service or a taxi dispatching service) may be exemplified.

### Advantageous Effects of Invention

According to the present disclosure, the service demand potential can be accurately predicted for each area in consideration of not only information related to the own-company service provision but also information related to the service provision of a competitor.

### BRIEF DESCRIPTION OF DRAWINGS

FIG. 1 is a functional block diagram of a service demand potential prediction device according to a first and second embodiment.

FIG. 2 is a diagram for explaining prediction of service demand potential using machine learning by a construction unit and a machine learning model by a prediction unit.

FIG. 3 is a flow chart showing a process executed the service demand potential prediction device according to the first embodiment.

FIG. 4(a) is a graph showing a dominant area and a non-dominant area, and the number of services provided by own-company service A in each of these areas; FIG. 4(b) is a graph showing the number of services provided by own-company service A in the non-dominant area; and FIG. 4(c) is a graph showing a predicted value of the service demand potential of own-company service A in the non-dominant area.

FIG. 5 is a flow chart showing processing executed by the service demand potential prediction device according to the second embodiment.

FIG. 6 is a diagram showing a hardware configuration example of a service demand potential prediction device.

### DESCRIPTION OF EMBODIMENTS

Embodiments of the invention according to the present disclosure will be described with reference to accompanying drawings. Hereinafter, as a first embodiment, an embodiment where an area (hereinafter referred to as a “non-dominant area”) that is not an area (hereinafter referred to as a “dominant area”) in which the number of service provision results of the own-company service is relatively dominant is selected without limiting the user attribute, and the service demand potential in the non-dominant area is predicted will be described. As a second embodiment, an embodiment where a non-dominant area for the target user attribute is selected and the service demand potential in the non-dominant area for the target user attribute is predicted will be described. In these first and second embodiments, an example of providing an electronic payment service as a target “service” is explained, and a payment service provided by the target company is referred to as “own-company service A (or service A)” and a payment service provided by a competitor is referred to as “other-company service B (or service B)”. Where possible, the same parts are denoted by the same reference numerals, and repeated description will be omitted.

### First Embodiment

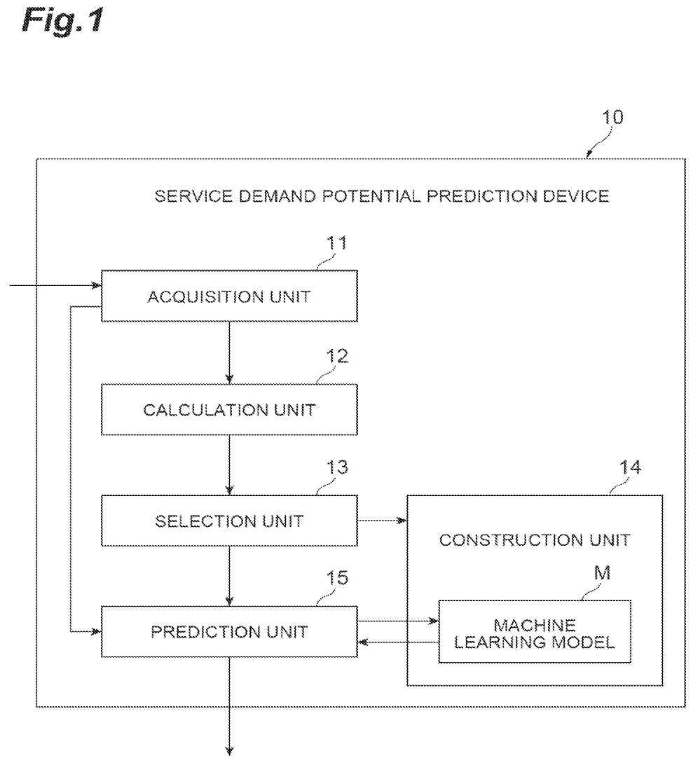

As shown in FIG. 1, a service demand potential prediction device 10 includes an acquisition unit 11, a calculation unit 12, a selection unit 13, a construction unit 14, and a prediction unit 15. The functions of each unit will be described below.

The acquisition unit 11 is a function unit that acquires the number of service provision results for each of the target own-company service and the other-company service for each predetermined area, the number of service provision results for the other-company service is used for calculation of a relative index indicating a relative ratio of the number of service provision results for the other-company service to that for the own-company service. The “number of service provision results” may include application statistical information relating to the number of times the user has executed payment processing in the payment service, or application statistical information relating to the number of times the user has started an application for using the payment service. The application statistical information obtained in such a manner that the user is not identified is used as the “number of service provision results”. For convenience, application statistical information relating to the number of times of executing the payment processing is hereinafter referred to as “payment number”, and application statistical information relating to the number of times of starting the application is hereinafter referred to as “application start number”. Hereinafter, an example in which “number of payments” is used as “number of service provision results” will be described.

The calculation unit 12 is a function unit for calculating a relative index of the own-company service to the other-company service for each area based on the acquired number of service provision results for the own-company service and the other-company service for each area. When calculating the relative index in a certain area, the calculation unit 12 calculates (the number of service provision results of the own-company service/(the number of service provision results of the own-company service+the number of service provision results of the other-company service)) and uses it as a relative index in the area. In addition to the above, for example, a method may be employed in which (the number of services provided by the target company/the number of services provided by other companies) is calculated and used as a relative index in the area. However, in the case of (actual number of services provided by the target company/actual number of services provided by other companies), the relative index may be a very large value. On the other hand, in the case of the method using (actual number of services provided by the target company/(actual number of services provided by the target company+actual number of services provided by other companies)) as the relative index, since the relative index is within the range of 0 to 1, the relative index can be easily handled.

The selection unit 13 is a functional unit for selecting a dominant area in which the number of service provision results of the own-company service is relatively dominant based on the information including the calculated relative index for each area. The selection by the selection unit 13 can be performed by various methods, and three selection methods will be exemplified later.

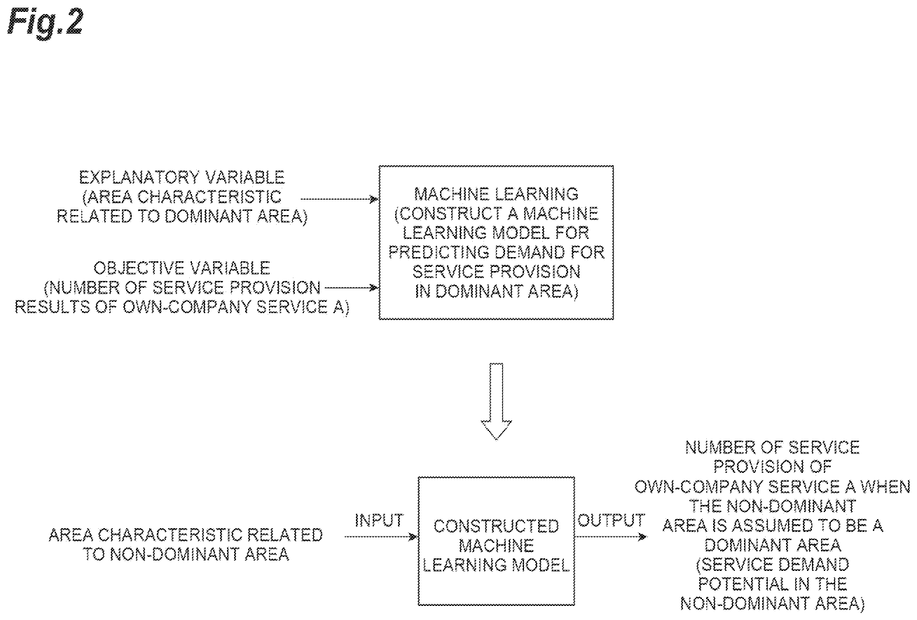

As shown in FIG. 2, the construction unit 14 is a function unit for constructing a machine learning model M for predicting a demand for service provision in the dominant area by performing machine learning using a characteristic amount representing the characteristic of the selected dominant area as an explanatory variable and the number of service provision results of the own service in the selected dominant area (here, for example, the number of service payments of the own service in the dominant area) as an objective variable. Examples of the “characteristic amount representing the characteristic of the dominant area” as the above-mentioned explanatory variable include the daytime and nighttime population by sex age in the dominant area aggregated on a time basis based on (a) the location information of the terminal, the location information, and the like, (b) the number of member stores corresponding to payment located in the dominant area, and (c) the characteristic amount representing the characteristics of the dominant area (for example, characteristics of areas such as commercial areas, residential areas, industrial areas, urban centers, and suburban areas). Although an example in which the construction unit 14 stores and manages the constructed machine learning model M is shown here, the machine learning model M may be stored and managed by another function unit included in the service demand potential prediction device 10.

As shown in FIG. 2, the prediction unit 15 is a functional unit for predicting a service provision prediction number of the own-company service in a case where a non-dominant area is assumed to be a dominant area by inputting a characteristic amount representing a characteristic of the non-dominant area which is not the dominant area into the constructed machine learning model, and setting the obtained service provision prediction number as a service demand potential in the non-dominant area. Further, the prediction unit 15 has a function of outputting (for example, displaying on a display) the service demand potential in the non-dominant area obtained by the prediction. The prediction unit 15 may further calculate a difference between the service demand potential in the non-dominant area and the number of service provision results, and output the obtained difference together with the service demand potential in the non-dominant area, or output the difference only instead of the service demand potential in the non-dominant area.

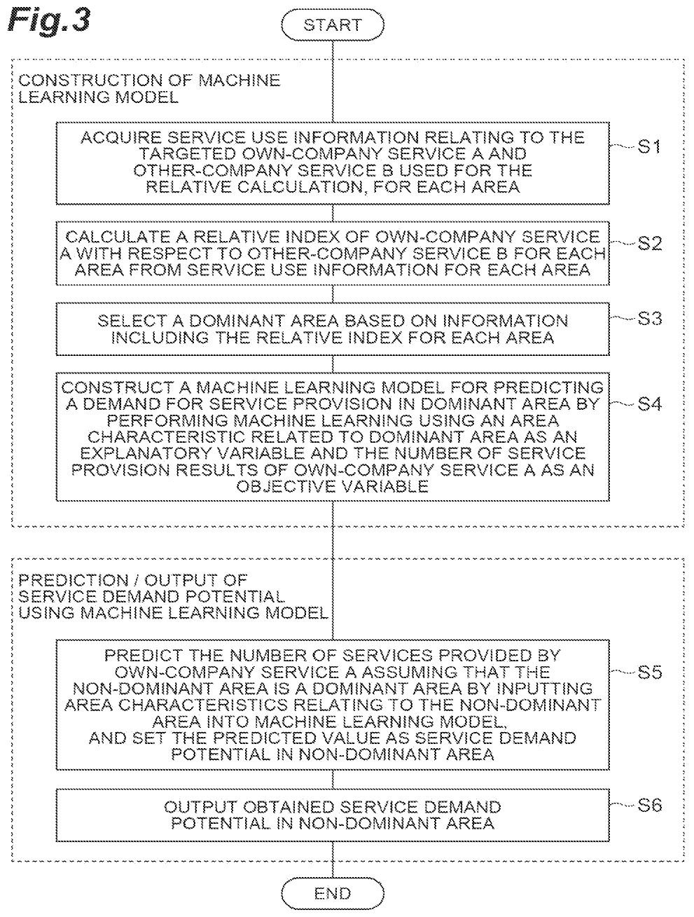

Next, the processing executed by the service demand potential prediction device 10 will be described along the flow chart of FIG. 3. As shown in FIG. 3, this process is roughly divided into the construction of the machine learning model in the first half (steps S1 to S4) and the prediction/output of the service demand potential using the machine learning model in the second half (steps S5 to S6).

First, regarding the construction of the machine learning model in the first half, the acquisition unit 11 acquires service usage information relating to the own-company service A and the other-company service B used for the relative calculation for each area (step S1), and the calculation unit 12 calculates a relative index of the own-company service A with respect to the other-company service B for each area from the service usage information for each area (step S2). Here, as described above, the calculation unit 12 calculates (the number of service provision results of the own-company service/(the number of service provision results of the own-company service+the number of service provision results of the other-company services)) and uses it as a relative index in the area. Then, the selection unit 13 selects a dominant area by a method to be described later on the basis of information including a relative index for each area (step S3), and the construction unit 14 constructs a machine learning model for predicting a demand for service provision in the dominant area by performing machine learning using an area characteristic related to the dominant area as an explanatory variable and the number of service provision results of the own-company service A as an objective variable, as shown in FIG. 2 (step S4). Through the above-described steps S1 to S4, a machine learning model for predicting the demand for service provision in the dominant area is constructed.

Here, three examples of the selection method of the dominant area in step S3 will be described.

A first example is a method of selecting an area that is sufficiently dominant in terms of market share as the dominant area in service usage information. When the market share of each service is known, and the combined market share of the own-company service A and the other-company service B can be grasped, this method according to the first example is very effective, and a dominant area can be appropriately selected based on the market share information. For example, if the multiplication result of the relative index P for a certain area and the combined market share of the target services (the above-mentioned services A and B) exceeds a predetermined threshold (for example, 0.5), the area is selected as a dominant area. For example, if the market share of the own-company service A is 22%, the market share of the other-company service B is 48%, the relative index P for a certain area is 0.75, and the threshold is 0.5, then the relative index P×combined market share of target services=0.75×(0.22+0.48)=0.525

and since the multiplication result exceeds the threshold (0.5), the area is selected as a dominant area. In the first example above, an additional condition that “the relative index P for each area does not fall below a predetermined reference value (for example, 0.5)” may be added. Also, as the market share of each service, the national market share may be used, or the market share at a predetermined regional level (for example, the Kanto region) or a predetermined prefectural level (for example, Kanagawa Prefecture) may be used.

A second example is a method of selecting an area that is sufficiently superior to the service B used for the relative calculation as the dominant area, using two of the relative indices for all areas and the relative index for each area. Even if the combined market share mentioned in the first example is unknown, this method selects, as a dominant area, an area that is sufficiently superior to the service B of the main service provider selected as a comparison target, by using the relative index for the own-company service A against the other-company service B of the main service provider in all areas (hereinafter referred to as “reference relative index”) P′. Specifically, in this method, instead of the market share, the reference relative index P′ for the own-company service A against the other-company service B in all areas is calculated, and the value obtained by multiplying the obtained reference relative index P′ by a predetermined adjustment parameter a is set as the threshold, and an area where the relative index P for the own company service A against the service B exceeds the above threshold is selected as a dominant area. According to the method according to the second example, even if the market share of each service is not known, the reference relative index for the entire area is calculated, and the obtained reference relative index is used together with the relative index for each area to appropriately select a dominant area. For example, if the reference relative index P′ calculated from the ratio of payment counts for services A and B in all areas is 0.33, the relative index P for a certain area is 0.75, and the adjustment parameter a used for adjusting the threshold is 2, then the relative index P (0.75) for the area exceeds a threshold (0.66) obtained by the adjustment parameter a (2)×reference relative index P′ (0.33), so the area can be judged as an area that is sufficiently superior to the reference relative index P′ for the relative index P for the area, and the area is selected as a dominant area.

A third example corresponds to a simplified version of the second example above, and does not calculate the reference relative index P′ for the entire area, but uses only the relative index P for each area. That is, it is a method of selecting an area where the relative index P for a certain area exceeds a predetermined threshold (for example, 0.5) as a dominant area. For example, if the relative index P for a certain area exceeds the threshold (0.5) and is 0.75, the area is selected as a dominant area. According to the method according to the third example, even if the market share of each service is not known, a dominant area s can be easily selected using only the relative index for each area.

Next, returning to FIG. 3, the prediction and output of the service demand potential using the machine learning model in the latter half will be described. As shown in FIG. 2, the prediction unit 15 inputs the area characteristics relating to the non-dominant area into the machine learning model M read from the construction unit 14, thereby predicting the number of services provided by the own-company service A assuming that the non-dominant area is a dominant area, and sets the predicted value as a service demand potential in the non-dominant area (step S5). Further, the prediction unit 15 outputs (for example, displays on a display) the service demand potential in the non-dominant area obtained by the prediction (step S6). In step S6, the prediction unit 15 may further calculate a difference between the service demand potential in the non-dominant area and the number of service provision results, and output the obtained difference together with the service demand potential in the non-dominant area, or output the difference only instead of the service demand potential in the non-dominant area.

According to the first embodiment described above, the service demand potential can be accurately predicted for each area in consideration of not only information related to the service provision of the own-company but also information related to the service provision of the other-company. Further, the service demand potential can be predicted relatively easily as described above by using a relative index for each area obtained on the basis of the actual number of service provision results in each area for the own-company service and the other-company service without using a detailed and large data for predicting the demand for service provision.

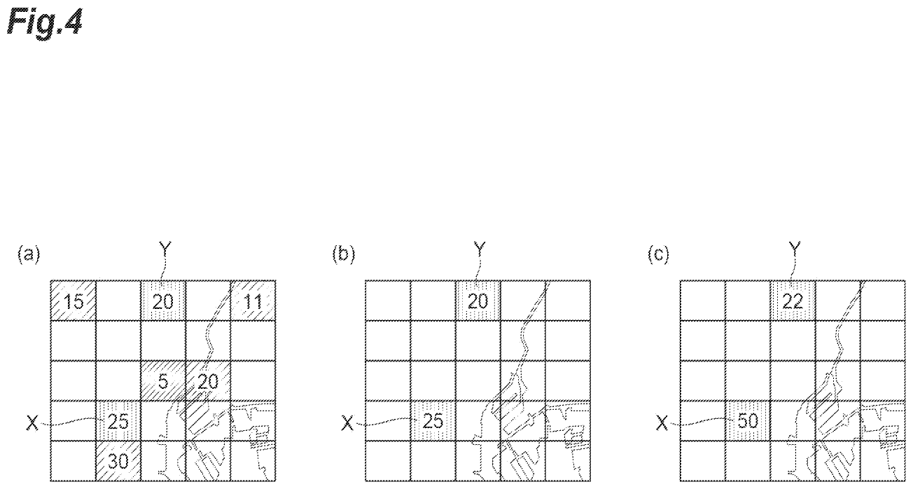

For example, when an area with diagonal hatching is selected as a dominant area in a plurality of areas shown in FIG. 4(a), a machine learning model for predicting the demand for service provision in the dominant area is constructed by performing machine learning using the area characteristics related to the dominant area as an explanatory variable and the number of service provision results of own-company service A as an objective variable. Then, taking two non-dominant areas X and Y with vertical hatching in FIG. 4(a) as an example among non-dominant areas other than the dominant area, when the number of service provision results of the own-company service A in the non-dominant areas X and Y shown in FIG. 4(b) is compared with the predicted value of the service demand potential of the own-company service A in the non-dominant areas X and Y shown in FIG. 4(c), it is found that the predicted value (22) of the service demand potential for the non-dominant area Y is not much different from the number of service provision results (20), but the predicted value (50) of the service demand potential for the non-dominant area X is much different from the number of service provision results (25). As a result, it is possible to obtain useful knowledge that the non-dominant area X has a very high service demand potential of the own-company service A and is a promising area as a target for future sales activities. When a promising area having a large difference in the predicted value of the service demand potential with respect to the number of service provision results cannot be found, such as the non-dominant area X described above, it is desirable that, for example, the condition at the time of the dominant area selection is made strict (for example, the predetermined threshold value is reset high) and the processing after the dominant area selection is executed again.

### Second Embodiment

As a second embodiment, an embodiment in which a non-dominant area for a target user attribute is selected and a service demand potential in the non-dominant area for the target user attribute is predicted will be described below. It should be noted that the user attribute information of various users is acquired from application statistical information acquired in a form that does not identify the user from the terminal of various users, as an example.

The functional block configuration of the service demand potential prediction device 10 is the same as that shown in FIG. 1 described in the first embodiment. However, each of the functional units has additional functions as follows.

The acquisition unit 11 has a function of further acquiring user attribute information of a user who uses services for each of the own-company service and the other-company service, for each area.

The calculation unit 12 has a function of calculating a relative index for a target user attribute for each area based on the acquired user attribute information and the number of service provision results.

The selection unit 13 has a function of selecting a dominant area for a target user attribute based on information including a relative index for each area for the target user attribute.

The construction unit (14) has a function of constructing a machine learning model for predicting a demand for service provision in a dominant area with respect to a target user attribute by performing machine learning using a characteristic amount representing the characteristic of the dominant area with respect to the target user attribute as an explanatory variable and the number of service provision results of the own service in the dominant area with respect to the target user attribute as an objective variable.

The prediction unit (15) has a function of inputting a characteristic amount representing a characteristic of a non-dominant area with respect to a target user attribute into the constructed machine learning model, thereby predicting the service provision prediction number of the own-company service when the non-dominant area is assumed to be a dominant area, and using the obtained service provision prediction number as the service demand potential in the non-dominant area with respect to the target user attribute.

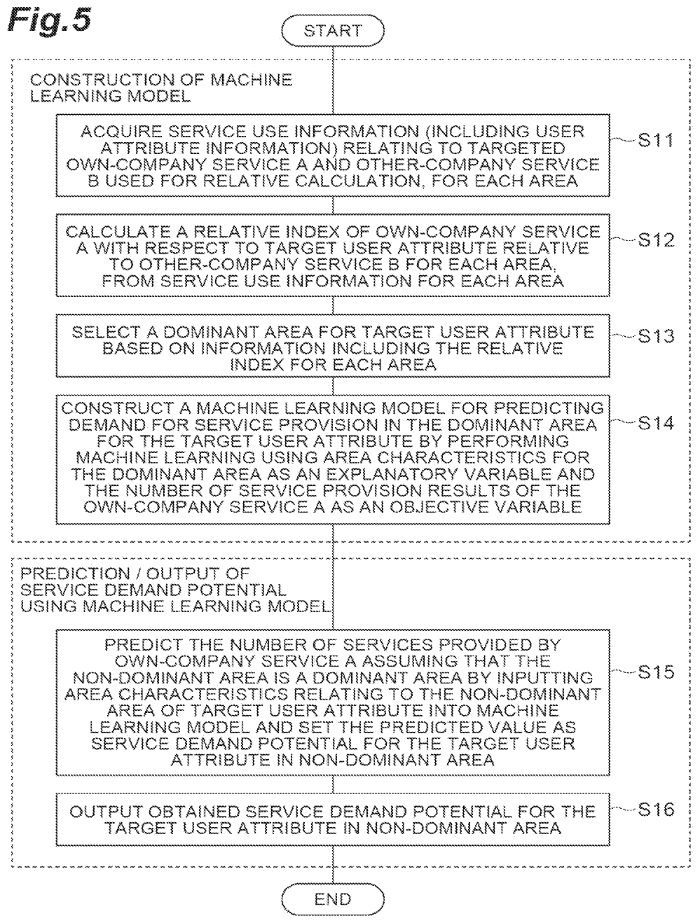

Next, the processing executed by the service demand potential prediction device 10 will be described along the flow chart of FIG. 5. Similar to the processing of FIG. 3 described in the first embodiment, this processing is roughly divided into the construction of a machine learning model in the first half (steps S11 to S14) and the prediction/output of a service demand potential using the machine learning model in the second half (steps S15 to S16).

First, regarding the construction of the machine learning model in the first half, the acquisition unit 11 acquires service use information (including user attribute information) relating to the own-company service A and the other-company service B used for the relative calculation for each area (step S11), the calculation unit 12 calculates a relative index of the own-company service A with respect to the target user attribute, to the other-company service B for each area from the service use information for each area (step S12), and the selection unit 13 selects a dominant area for the target user attribute on the basis of the information including the relative index for each area using any of the methods exemplified in the first embodiment (step S13). Further, the construction unit 14 constructs, stores and manages a machine learning model for predicting a demand for service provision in the dominant area for the target user attribute by performing machine learning using the area characteristic for the dominant area as an explanatory variable and the number of service provision results of the own-company service A as an objective variable (step S14).

Next, regarding the prediction and output of the service demand potential using the machine learning model in the latter half, the prediction unit 15 inputs the area characteristics relating to the non-dominant area of the target user attribute, into the machine learning model M read from the construction unit 14, thereby predicting the number of service offerings of the own-company service A assuming that the non-dominant area is a dominant area, and sets the predicted value as a service demand potential in the non-dominant area of the target user attribute (step S15). Further, the prediction unit 15 outputs the service demand potential in the non-dominant area for the target user attribute (step S16). In step S16, the prediction unit 15 may further calculate a difference between the service demand potential and the number of service provision results in the non-dominant area, and output the obtained difference together with the service demand potential in the non-dominant area, or output the difference only instead of the service demand potential in the non-dominant area.

According to the second embodiment described above, after selecting a non-dominant area for a target user attribute, the service demand potential for the target user attribute can be accurately predicted for each area in consideration of not only information related to the own-company service provision but also information related to the other-company service provision.

In the above-described first and second embodiments, an example in which the “number of payment times” is used as the “number of service provision results” has been described, but the “number of application start times” which is the number of times the user has started an application for using the payment service may be used as the “number of service provision results” instead of the “number of payment times”.

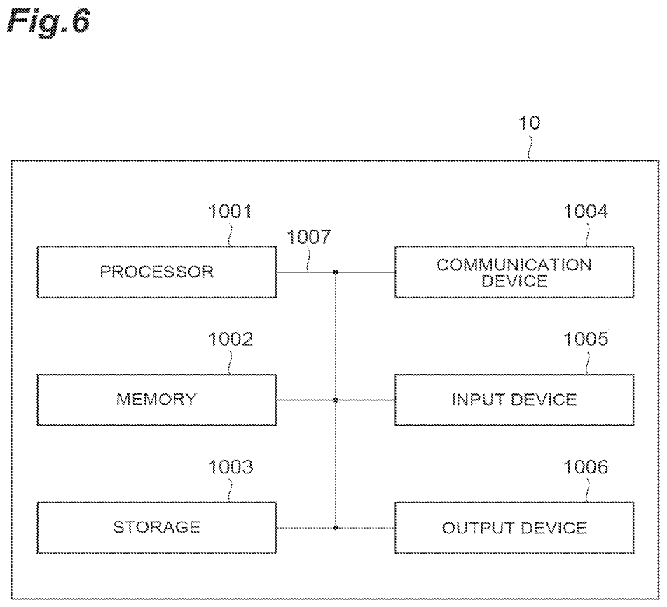

### (Explanation of Terms, Explanation of Hardware Configuration (FIG. 6), and the Like)

The block diagrams used in the description of the above embodiment show blocks in functional units. These functional blocks (configuration units) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

For example, the service demand potential prediction device of the present disclosure may function as a computer that performs processing in the present embodiment. FIG. 12 is a diagram showing an example of the hardware configuration of the service demand potential prediction device 10. The service demand potential prediction device 10 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a unit, and the like. The hardware configuration of the service demand potential prediction device 10 may include one or more devices for each device shown in the diagram, or may not include some devices.

Each function in the service demand potential prediction device 10 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. Although it has been described that the various kinds of processes described above are performed by one processor 1001, the various kinds of processes described above may be performed simultaneously or sequentially by two or more processors 1001. The processor 1001 may be realized by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to implement the radio communication method according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium described above may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel). In addition, respective devices, such as the processor 1001 and the memory 1002, are connected to each other by the bus 1007 for communicating information. The bus 1007 may be configured using a single bus, or may be configured using a different bus for each device.

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be realized as modified and changed aspects without departing from the spirit and scope of the present disclosure defined by the description of the claims. Therefore, the description of the present disclosure is intended for illustrative purposes, and has no restrictive meaning to the present disclosure.

In the processing procedure, sequence, flowchart, and the like in each aspect/embodiment described in the present disclosure, the order may be changed as long as there is no contradiction. For example, for the methods described in the present disclosure, elements of various steps are presented using an exemplary order. However, the present invention is not limited to the specific order presented.

The information and the like that are input and output may be stored in a specific place (for example, a memory) or may be managed using a management table. The information and the like that are input and output can be overwritten, updated, or added. The information and the like that are output may be deleted. The information and the like that are input may be transmitted to other devices.

The description “based on” used in the present disclosure does not mean “based only on” unless otherwise specified. In other words, the description “based on” means both “based only on” and “based at least on”.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, when articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separated”, “coupled” may be interpreted similarly to “different”.

### REFERENCE SIGNS LIST

10: service demand potential prediction device; 11: acquisition unit; 12: calculation unit; 13: selection unit; 14: construction unit; 15: prediction unit; M: machine learning model; 1001: processor, 1002: memory, 1003: storage, 1004: communication device, 1005: input device, 1006: output device, 1007: bus.

1. A service demand potential prediction device comprising:
an acquisition unit that acquires the number of service provision results for each of a target own-company service and an other-company service used for calculating a relative index indicating a relative ratio to the own-company service with respect to the number of service provision results, for each predetermined area;
a calculation unit that calculates the relative index of the own-company service to the other-company service for each area based on the acquired number of service provision results for each of the target own-company service and the other-company service, for each area;
a selection unit that selects a dominant area in which the number of service provision results of the own-company service is relatively dominant, based on information including the calculated relative index for each area;
a construction unit that performs machine learning using a characteristic amount representing a characteristic of the selected dominant area as an explanatory variable and the number of service provision results of the own-company service in the selected dominant area as an objective variable, and constructs a machine learning model for predicting a demand for service provision in the dominant area;
a prediction unit that predicts a service provision prediction number of the own-company service in a case where a non-dominant area is assumed to be a dominant area by inputting a characteristic amount representing a characteristic of the non-dominant area which is not the dominant area into the constructed machine learning model, and sets the obtained service provision prediction number as a service demand potential in the non-dominant area.

2. The service demand potential prediction device according to claim 1,
wherein the acquisition unit further acquires user attribute information of a user who uses services for each of the own-company service and the other-company service for each area,
wherein the calculation unit calculates the relative index for a target user attribute for each area based on the acquired user attribute information and the number of service provision results,
wherein the selection unit selects the dominant area for the target user attribute based on information including the relative index for each area for the target user attribute,
wherein the construction unit performs machine learning using a characteristic amount representing a characteristic of the dominant area with respect to the target user attribute as an explanatory variable and the number of service provision results of the own-company service in the dominant area with respect to the target user attribute as an objective variable, and constructs a machine learning model for predicting a demand for service provision in the dominant area with respect to the target user attribute, and
wherein the prediction unit predicts a service provision prediction number of the own-company service in a case where the non-dominant area is assumed to be a dominant area, by inputting the characteristic amount representing the characteristic of the non-dominant area with respect to the target user attribute into the constructed machine learning model, and sets the obtained service provision prediction number as a service demand potential in the non-dominant area with respect to the target user attribute.

3. The service demand potential prediction device according to claim 1, wherein the prediction unit outputs at least one of:
the service demand potential in the non-dominant area, and
a difference between the service demand potential and the number of service provision results in the non-dominant area.

4. The service demand potential prediction device according to claim 1, wherein the calculation unit calculates, as the relative index for each area, a ratio of the number of service provision results of the own-company service to the sum of the number of service provision results of the other-company service and the number of service provision results of the own-company service.

5. The service demand potential prediction device according to claim 1, wherein the selection unit selects, as the dominant area, an area where a multiplication result of:
the calculated relative index for each area, and
a pre-acquired combined market share rate of the own-company service and the other-company service
exceeds a predetermined threshold.

6. The service demand potential prediction device according to claim 1, wherein the selection unit calculates a reference relative index indicating a relative ratio of the own-company service to the other-company service for all areas based on the number of service provision results of the own-company service and the number of service provision results of the other-company service in all areas, and selects, as the dominant area, an area where the relative index for each area exceeds a multiplication result of the reference relative index and a predetermined coefficient for threshold adjustment.

7. The service demand potential prediction device according to claim 1, wherein the selection unit selects, as the dominant area, an area where the calculated relative index for each area exceeds a predetermined threshold.

8. The service demand potential prediction device according to claim 2, wherein the prediction unit outputs at least one of:
the service demand potential in the non-dominant area, and
a difference between the service demand potential and the number of service provision results in the non-dominant area.
